(19) United States
(12) Patent Application Publication
(10) Pub. No.: US 2006/0142402 A1
(43) Pub. Date: Jun. 29, 2006

(54) Improved Robustness Wood Post Achoring Method

(75) Inventor: Clarence John Dunnrowicz, Santa Cruz, CA (US)

Correspondence Address: Clarence Dunnrowicz, 8901 Empire Grade Rd., Santa Cruz, CA, 95060, US

(73) Assignee: Mr. Clarence John Dunnrowicz, Santa Cruz, CA (US)

(21) Appl. No.: 11/308,360

(22) Filed: Mar. 18, 2006

(51) Int. Cl. C08J 9/16

(52) U.S. Cl. 521/56

(57) ABSTRACT

A chemically untreated wood post has the end grain sealed against moisture penetration and strengthened using a combination of penetrating epoxy, polyurethane sealant, and thin stainless steel sheet end cap. A coated rebar tension rod extension is internally epoxied into the wood post. This post-anchor assembly is rigidly locked onto an above grade, elevated concrete footing using an expansive grout surface layer.

A wood post anchoring method is described which addresses the deleterious effects of wood contact to soil or concrete, moisture induced post end cracking, cross grain penetration and splitting by exposed mechanical fasteners, and corrosion of post standard metal connectors.

Inventor/Assignee: Clarence Dunnrowicz

### REFERENCES CITED

### U.S. Patent Documents

| | | |
|---|---|---|
| 6461084 | October 2002 | Stuart, I. |
| 6560935 | May 2003 | Barefield, et al |
| 6729089 | May 2004 | Spragg, R. |

### Other Publications

Prowell, C.—Charles Prowell Woodworks Installation Guide, http://www. prowellwoodworks.com/installation_full.pdf
Morrison, D.—“Pressure Treated Wood: The Next Generation”, Fine Homebuilding #160,pp. 82-85, Taunton Press

### BACKGROUND OF THE INVENTION

1. Field of Invention

This invention is directed to the anchoring of wood posts. Specifically, this invention is directed toward applications in which high rainfall, soil moisture content, acidic rain, corrosion, utilization of pressure treated wood is objectionable, or maximum lifetime are major factors.

2. Description of Related Art

The vertical attachment of wood posts is a basic foundation requirement for many structures. Although there are many advantages to the selection of wood as a post material, the problem of decay is often the determining factor in the resultant waste of time, labor, and material involved in the replacement of the otherwise serviceable above ground structure.

The use of more decay resistant species such as redwood or cedar has been the historical preferred choice for this application. However, the availibility of tight grain, old growth wood necessary for the expected decay resistance is severely limited, and many would consider innapropriate use of an irreplaceable resource. New growth wood is expensive, and because of open grain structure does not have the necessary decay resistance.

To improve decay resistance one alternate approach is to use less expensive and decay resistant species which are surface impregnated with copper and arsenic compounds. However, these compounds are highly toxic and during structure fabrication can leave exposed sections prone to decay, speeding the inevitable release of these non-biodegradable inorganic compounds into the soil and water.

Approximately 20,000 tons of toxic chromated copper arsenate (CCA) was used yearly before being banned by the EPA in 2004. However, it is still permitted for agricultural, industrial, and certain residential applications.

Although CCA is being phased out by less toxic alkaline copper quat and copper azole compounds, this variant is even more expensive than CCA treated wood, plus, it is significantly more corrosive to steel fasteners. These higher costs necessitated manufacturers pressure treat to different saturation levels, and therefore grade lumber depending on end use. Such distribution and stocking complexity will add to overall cost and increase probability of using an improper lumber grade for a given application.

Various below ground post anchoring schemes exist in common literature, and historically have been accepted as standard construction practice. Common among these techniques is the cursory instruction to partially backfill the post hole bottom with gravel to allow water to drain away from post end grain. However, in many cases the effectiveness of this method is marginal for extending the post lifetime.

Prowell's improved method includes backfilling ⅔ of post hole with course gravel/pea gravel for improved drainage and then using a top concrete post collar for added stability. An approximate 4× increase in post longevity is claimed. For gate support requirements the post sits on a layer of gravel and the majority of post hole backfilled with concrete as in standard method. The large dimension (2-6×6 each side), high quality cedar gate posts are pre-treated with preservative (see Ref. Cited).

Above ground post anchoring methods usually entail assemblies which can be pre-driven into the ground, or post end attachments which connect to pre-existing wood, metal, or concrete footings. Note that most of these methods suffer from end grain water intrusion and poor transverse stability exacerbated by nailing near post end or elevating the post. Redwood and cedar tend to be brittle and subject to splintering. Most metal connectors are thin galvanized material which corrode rapidly when exposed to acidic rain, salt, chemicals found in back splash water, and pressure treated wood.

Stainless steel connectors are expensive special order items and often exhibit similar poor attachment practice. Typically, these standard designs list vertical or uplift force test results, but must rely on inter-connected top members for lateral strength, and are not recommended for fence lines. Test load results following accelerated environmental exposure are typically not available.

Design variations meant to improve transverse stability or exclude water by more rigid attachment methods are prone to failure because they do not accommodate seasonal wood movement. Anchors fabricated from plastic are most subject to ultraviolet degradation, and cracking from low temperatures or large thermal expansion mismatch.

### BRIEF SUMMARY OF THE INVENTION

A resilient, above ground wood post anchor assembly for new or retrofit concrete footings has been developed with primary focus on longevity. To satisfy these requirements, a three stage resilient wood end grain sealing process was developed in conjunction with a mechanical attachment method consistent with wood expansion and contraction.

First, the intrinsic end grain tendency to absorb water and split was reduced by applying a low viscosity penetrating epoxy. Epoxies have excellent adherence, low vapor permeability, and good mechanical properties to strengthen wood fibers. However, it is expected that over time seasonal wood movement will lead to small cracks developing in this surface layer.

Second, a marine grade polyurethane sealant is employed to seal these inevitable cracks and also form a resilient stress buffer layer between the post and lower stainless steel (SST) end cap plate seperator. Polyurethane is known for its good adhesive properties and exterior exposure performance. Further improvements can be realized by employing inorganic fillers. Alternate environmentally stable elastomeric, one and two-component compounds can be substituted for polyurethane sealant layer.

Third, a thin (˜18 ga.SST) sheet forms a corrosion resistant mechanical protection bottom end cap, spacing the above end grain seal off the hygroscopic concrete footing, and placing the polyurethane layer under compression. The SST spacer also assists with uniformly distributing the non-uniform end grain forces resulting from post variable lateral loads. There are no exposed cross grain penetrations by mechanical fasteners to weaken the highly stressed post end. The central rebar rod, SST spacer plate, and post cross sectional bearing area work together to resist the racking forces resulting from lateral loads.

The long term, above grade anchor resilience is the main focus of this invention, rather than the often short lived, initial rigidity of post standard burial methods. Within scope of this invention, additional lateral rigidity can be realized by increasing the cross sectional bearing area while addressing the seasonal wood movement requirement. For example, in FIG. 1 is shown a nominal 4×4 intermediate post with two side additions meant to increase cross section bearing area for resisting lateral loads perpendicular to a fence line. To one skilled in the art, laminating two or more structural wood members to resist the additional stresses of fence end and gate posts while accommodating wood movement is another further embodiment of this invention (FIG. 3). In this embodiment, the post side additions 2 shown in FIG. 1 can be omitted. This embodiment also makes efficient use of readily available standard lumber without requiring expensive and rare old growth, large dimensioned lumber with associated stability problems.

With the post anchor assembly effectively sealed against capillary water migration, and SST sheet bottom plate mechanically seperating post end from the elevated footing surface, there is no requirement to elevate post anchor above footing surface and compromise lateral rigidity. This can be accomplished during initial concrete footing fabrication, or by drilling a hole to accommodate the post anchor on a pre-existing footing by imbedding in structural epoxy.

In the case of a new concrete footing, a small shrinkage gap underneath the SST spacer bottom cap will typically develop after the initial concrete cure. The size of this gap will depend on well known factors of footing depth, concrete mix water content, curing conditions, etc. One method to eliminate this small gap is to leave approximately a two inch space under SST plate, let concrete footing cure overnight, and then fill the space with exterior grade grout. Grout typically has superior mechanical properties than normal concrete, is inexpensive, and if necessary can be further fortified for specific applications. Also, the formation method of the elevated concrete footing to be described permits self-leveling of nominal 4×4 intermediate post without using additional customary wooden lateral supports.

### BRIEF DESCRIPTION OF THE DRAWINGS

FIG. 1 Illustrates a side view for the post anchor assembly intended for mounting on a newly fabricated concrete footing. For mounting on a pre-existing concrete footing, the coated rebar 5 can be shortened from approximately 24″ to 5″.

FIG. 2 Illustrates a side view for the preferred example embodiment of the post anchor assembly shown in FIG. 1, mounted on a newly fabricated concrete footing as described below in Detailed Description of Preferred Embodiments.

FIG. 3 Illustrates a bottom view of an preferred embodiment example of a multiple post lamination for added lateral stability.

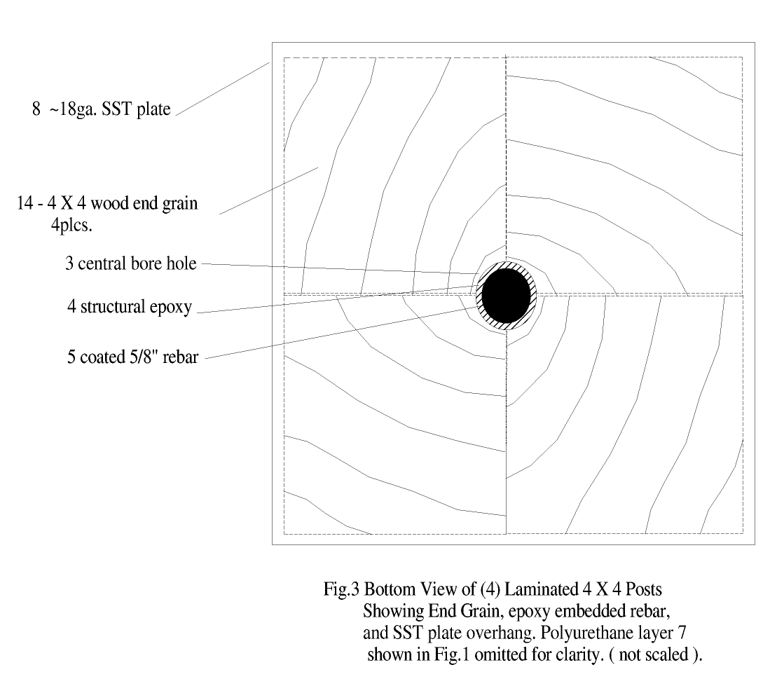

### DETAILED DESCRIPTION OF PREFERRED EMBODIMENTS

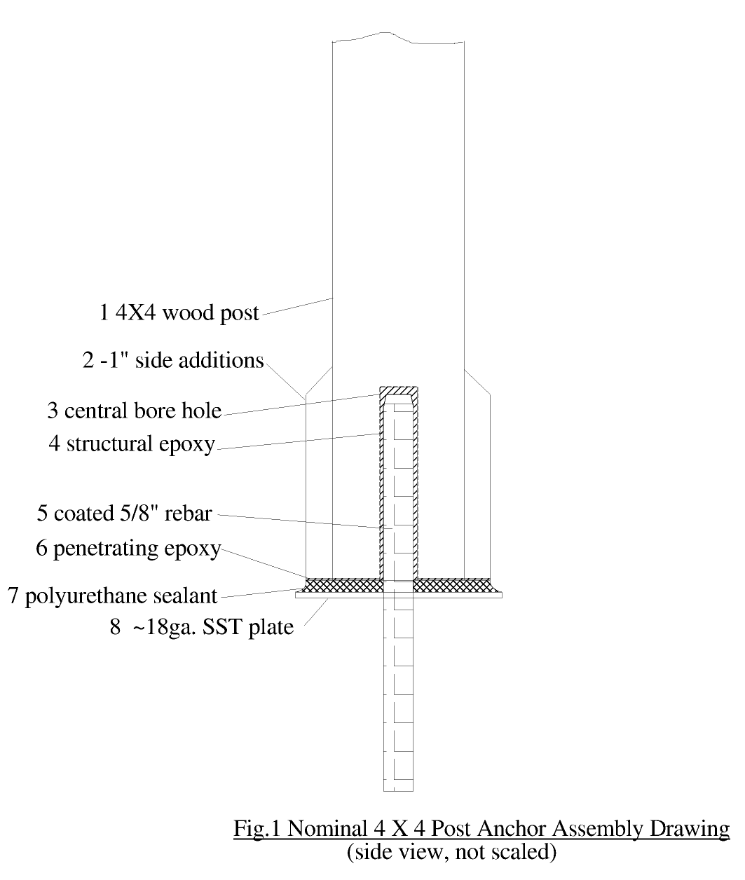

(FIG. 1) is a drawing of the post anchor assembly. The wood post should have 12-15% moisture content and dried in a manner to avoid checking or warping. Lightly plane all post surfaces, and for nominal 4×4 post, glue two 1″×8″ side additions 2 to increase lower cross section. Trim ends to remove checking, and break edges using ⅛″ radius round-over bit. The post sides have been planed and edges given slight radius round-over to improve weatherability and reduce splintering, respectively.

For standard 4×4″ nominal post drill ¾″ diameter perpendicular hole 3 approximately 5″ deep in post bottom end. Partially fill hole with sufficient structural epoxy 4, and insert ⅝″ diameter×24″ length coated rebar 5. For pre-existings footings, the rebar can be shorter. Remove excess epoxy and let cure according to manufacturer specification.

Fabricate nominal 18 ga. thickness stainless steel bottom plate 8 with ⅝″ center hole and exterior dimensions such that plate extends approximately ±¼″ larger than post bottom on all sides. Do not abrade or roughen SST plate.

Saturate post bottom and approximately ±½″ up post sides with penetrating epoxy 6. When epoxy surface become tacky, generously apply marine grade polyurethane sealant 7 to post bottom. Mount plate 8 onto rebar rod 5, align with post bottom, and lightly clamp to squeeze out excess polyurethane 7. The excess polyurethane squeezeout material should be molded or shaped to form a concave meniscus between the SST plate and post bottom edges. Let polyurethane sealant cure according to manufacturer instructions.

For pre-existing concrete footings drill appropriate size hole to accommodate protruding rebar rod 5, and imbed post anchor assembly using structural epoxy following manufacturer instructions.

According to an aspect of the invention, a preferred concrete footing fabrication method for above wood post anchor will now be outlined. For poor load bearing soils, extreme climates, high wind loading, chemical exposure, etc., appropriate modifications will be required by those skilled in the art without departing from the spirit and scope of the invention as defined in the claims. For instance, exposure to high salt conditions near marine environments may justify the use of pressure treated post 1,2, 316 stainless steel rebar rod 5, plate 8, and sulphate resistant concrete 13, to maximize overall longevity. In hard feezing climates, the footing depth and shape near surface grade will need to be modified to prevent heaving, etc.

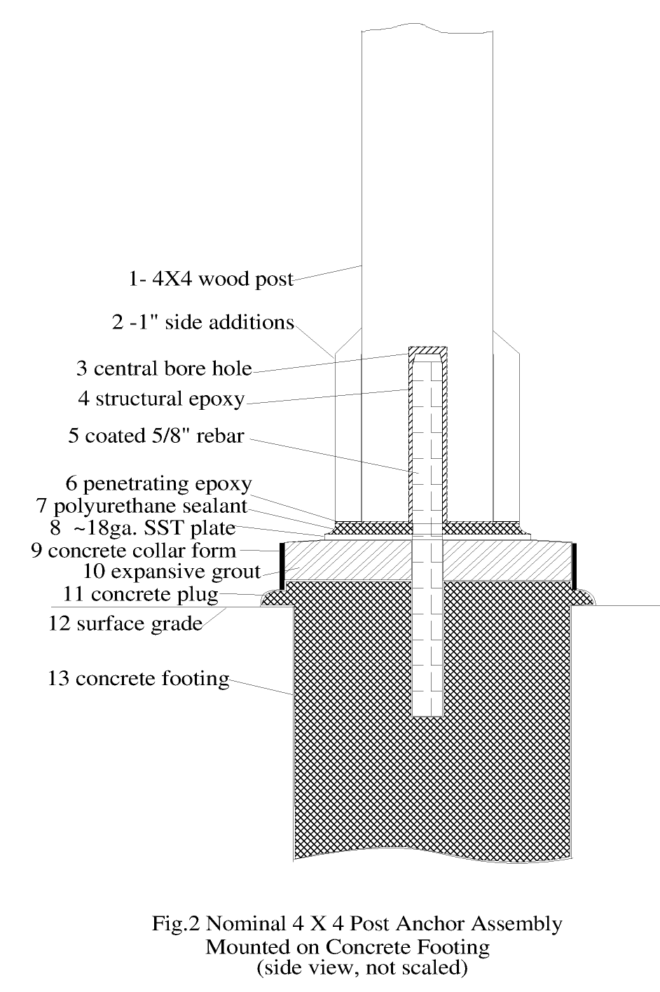

(FIG. 2) is an example drawing of the completed post anchor assembly mounted to new concrete footing. The following is a description of a preferred embodiment for footing fabrication within the scope of the post anchor invention meant to illustrate its advantages, and is not intended to be an instructional primer. No liability is assumed for any resultant property damage or personal injury that may result from the description unintended usuage. Local building codes should be followed, and consult with a structural engineer as required.

The following method can be performed by a single individual. For 4×4, 6 ft. intermediate fence posts in average soil, dig post hole using an auger approximately 6″ diameter by 36″ deep. Remove any loose soil along hole sides and bottom. Backfill with approximately 3″ of coarse gravel. Cut hole in plastic sheet to be used as large concrete funnel and place over post hole. Using concrete mixer, thoroughly mix concrete according to instructions. Do not add excess water, and keep mixture slightly stiff. Pour mixture into post hole, and then use a concrete vibrator to consolidate voids. Add additional concrete as necessary such that as vibrator is withdrawn from the hole, excess concrete on the plastic sheet funnel will flow into hole and form an above grade, self-leveling plug slightly wider than hole and approximately two inches above grade (refer to FIG. 2). Remove plastic sheet and briefly trowel the concrete as necessary to shape plug edges. Position a 8″ diameter by 3″ high concrete collar form on concrete surface plug, re-level as necessary, and then place two temporary ⅛″ thick steel supports across collar form (temporary supports not shown in FIG. 2). This method facilitates leveling of collar form while minimizing soil disturbance. Let concrete stiffen slightly, attach dual axis level to post, and insert post rebar anchor 5 into concrete paying attention to lateral post alignment. With post anchor bottom plate 8 resting on temporary steel collar supports, level post vertically, and let concrete cure over night.

Remove temporary steel bridging supports, and there should be an approximate 2-3″ gap between post anchor bottom plate 8 and top of concrete. Fill this gap with good quality, exterior grade anchoring grout and pea gravel mixture. A grout with one hour pot life will allow a more relaxed working pace when backfilling several posts. Do not disturb post while grout cures, and avoid strong, direct sun exposure.

Although post footing sits above soil level, it is suggested that coarse gravel or stone be spread around footing after concrete form 9 is removed. This will reduce soil splash back during heavy rain, and facilitate removal of normal ground litter buildup using a leaf blower. Keep forest litter and any soil buildup below footing top surface. After concrete footing fully cures it is also suggested to speed water runoff by coating wooden post with a preservative that can also be applied to footing. However, only lightly coat post top end to facilitate water evaporation. A post top cap should also be used to prevent sun exposure and water intrusion along end grain wood fibers.

What is claimed is:

1. A wood post end grain environmental triple seal and mechanical anchoring method comprising: an internal anchor of coated rebar rod epoxied into a centrally drilled hole in wood post end; low viscosity penetrating epoxy coating of anchor end grain to seal and fortify wood fibers; an elastomeric and adhesive polyurethane layer applied over the penetrating epoxy to seal any cracks plus facilitate the free wood movement relative to the stainless steel bottom end cap; a stainless steel bottom end cap which functions as a mechanical and environmental protection plate.

2. For 4×4 intermediate posts to be installed on new concrete footings, the extended end of rebar rod together with temporary steel shims placed across concrete collar form provides post leveling stabilization during concrete curing without the standard requirement for additional lateral support.

3. A two part concrete footing structure in which the initial pour and cure leaves an approximate 2 inch space under the post stainless steel bottom plate. This space is subsequently back filled with an expansive grout, rigidly locking the post to the concrete footing and eliminating the effects of concrete shrinkage.
